(19) United States
(12) Patent Application Publication
(10) Pub. No.: US 2011/0033658 A1
(43) Pub. Date: Feb. 10, 2011

(54) COMPOSITION OF A RADIATION REFLECTING BREATHER MEMBRANE

(76) Inventors: Ivan Boeykens, Merksem (BE); Bart Van Edom, Scherpenheuvel-Zichem (BE); Mieke Vanhoof, Berchem (BE)

Correspondence Address: BACON & THOMAS, PLLC, 625 SLATERS LANE, FOURTH FLOOR, ALEXANDRIA, VA, 22314-1176, US

(21) Appl. No.: 12/851,087

(22) Filed: Aug. 5, 2010

(30) Foreign Application Priority Data
Aug. 6, 2009 (EP) 09447036.6

(51) Int. Cl. B32B 3/10

(52) U.S. Cl. 428/138

(57) ABSTRACT

Composition of a radiation reflecting breather membrane, characterized in that it consists of two composed layer packages, respectively an outer layer package and an inner layer package, which are fused, whereby the outer layer package comprises a monolithic polyethylene (PE) layer and a metallic or metalized radiation reflecting layer on the outside and a substrate layer on the inside, whereby this outer layer package is perforated, and whereby the inner layer package comprises a monolithic layer with a thickness (A) of less than 100 micrometer of extruded thermoplastic polyurethane (TPU) or thermoplastic polyester-ether (TPEE) fused to the substrate layer of the aforementioned perforated outer layer package.

The present invention relates to a composition of a radiation reflecting breather membrane.

Breather membranes find applications amongst others as water vapor control membranes traditionally used at the outside of pitch roof constructions. The outside is the side oriented towards the radiation source, in this case daylight, and the inside is the side oriented towards the inside of the house. Such layers must allow water vapor to escape thereby protecting the roof space against damage caused by humidity, condensation and mould.

The water vapor control layer adapts itself to changing weather conditions and humidity rates. In winter it protects against water infiltration, in summer it allows moisture vapor to escape and allows the wooden frames to dry.

These traditional water vapor control layers however are degradable by UV radiation, are not fire resistant and are not very resistant to mechanical damage (nail and tear).

The purpose of the invention is to overcome these above mentioned and other disadvantages.

To this end, the invention comprises the following composition for a radiation reflecting breather membrane, characterized in that it consists of it consists of two composed layer packages, respectively an outer layer package and an inner layer package, which are fused, whereby the outer layer package comprises a monolithic polyethylene (PE) layer and a metallic or metalized radiation reflecting layer on the outside and a substrate layer on the inside, whereby this outer layer package is perforated, and whereby the inner layer package comprises a monolithic layer with a thickness (A) of less than 100 micrometer of extruded thermoplastic polyurethane (TPU) or thermoplastic polyester-ether (TPEE) fused to the substrate layer of the aforementioned perforated outer layer package.

Optionally the inner layer package can also be fused to a non woven polymer layer on the outside.

This inner layer package is not perforated and nonetheless offers a water vapor transmission rate of at least 600 g water vapor/m²/day.

The radiation reflecting breather membranes according to the invention are used on the outside of pitch roof and wall constructions and offer the advantage of being UV stable, water tight, fire resistant and mechanically strong against wear and tear.

They also offer the advantage of cutting energy loss through their radiation reflecting surface. In winter they retain heat within buildings. In summer, they reflect radiation preventing overheating.

The radiation reflecting membranes offer the advantage of being water tight, while they can be based on an extrusion coating technology according to another invention of the applicant which allows extrusion of very thin monolithic polymers with a thickness of less than 100 micrometers. In this way, thermoplastic polyurethane (TPU) or thermoplastic polyester-ether (TPEE) can be extruded in thicknesses between 8 to 100 micrometer. An extruded layer of 30 micrometer thick of TPU for instance has a water vapor transmission rate of at least 850 g/m²/day, and yet is monolithic and non perforated. With the same technology, thermoplastic polyester-ether (TPEE) can also be obtained with similar properties of water vapor transmission and water tightness.

Another advantage is that the membrane is resistant to degradation by UV radiation.

Another advantage is that the membrane remains smooth and silent when agitated by atmospheric conditions.

Another advantage is the combination of high resistance to mechanical damage of the composed membrane with a high transmission rate for water vapor, and of resistance to UV radiation, which is unequalled in existing breather membrane compositions.

Another advantage is given by the economical production technique which allows the use of affordable minimal quantities of TPU or TPEE to obtain a breathable yet monolithic membrane.

Another advantage of the membrane is that it can be used as a waterproof material or a water-vapor-permeable material for a wrapping material, fabric, a packing material, or a material for building protection.

With the intention of better showing the characteristics of the invention, hereafter, as an example without any limitative character, a preferred form of embodiment is described of a radiation reflecting breather membrane, with reference to the accompanying drawings, wherein:

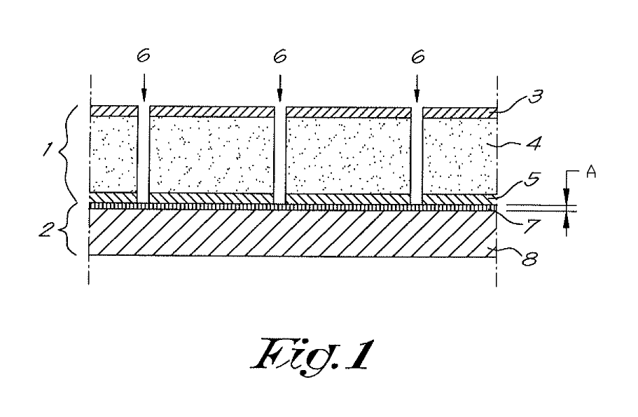

FIG. 1 schematically represents a cross section of a radiation reflecting membrane according to the invention.

The composition of the radiation reflecting membrane represented in FIG. 1 consists of

An outer layer package 1 and an inner layer package 2 that are fused together whereby the outer layer package 1 is composed of a metalized or metallic radiation reflecting layer 3 on the outside of a monolithic polyethylene (PE) layer 4 lined by a substrate layer 5 (preferably 30-70 g/m²) at the inside. This outer layer package 1 is perforated by mechanical or other means, to allow water vapor to cross the three composing layers 3,4,5 through the perforations 6.

The inner layer package 2 consists of a very thin extruded layer 7 of TPU or TPEE, optionally lined on the outside by a non woven polymer layer 8 (preferably 70-150 g/m²).

The inner layer package 2 is not perforated but offers a good water vapor transmission rate due to the very low thickness A of 8 to 100 micrometer of the monolithic TPU or TPEE polymer layer 7. The inner layer package 2 is fused to the substrate layer 5 of the outer layer package 1 by for instance a lamination process or by any other fusion means such as the use of glues.

The substrate layer 5 can be a porous or non porous material, woven or nonwoven polymers, film, metalized film, aluminum, paper, scrim, glass fiber tissue, or textile. If the substrate is a nonwoven polymer, its weight is preferably 30-70 g/m².

The present invention is in no way limited to the membrane composition described by way of an example and represented in the figures, however, such a membrane composition according to the invention can be realized in various forms without leaving the scope of the invention.

1-6. (canceled)

7. A radiation reflecting breather membrane, comprising two composed layer packages, including an outer layer package and an inner layer package, said packages being fused, and wherein the outer layer package comprises a monolithic polyethylene (PE) layer and a metallic or metalized radiation reflecting layer on the outside and a substrate layer on the inside; said outer layer package being perforated; and wherein the inner layer package comprises a monolithic layer with a thickness of less than 100 micrometer and comprising extruded thermoplastic polyurethane (TPU) or thermoplastic polyester-ether (TPEE) fused to the substrate layer of the perforated outer layer package.

8. The radiation reflecting breather membrane according to claim 7, wherein the inner layer package is also fused to a non-woven polymer layer on the outside.

9. The radiation reflecting breather membrane according to claim 7, wherein the inner layer package is not perforated but has a water vapor transmission rate of at least 600 g water vapor/m²/day.

10. The radiation reflecting breather membrane according to claim 7, wherein the radiation reflecting layer comprises an aluminum layer deposited on a carrier polymer layer or a metal film.

11. The radiation reflecting breather membrane according to claim 7, wherein the substrate layer comprises porous or non porous material, woven or nonwoven polymers, film, metalized film, aluminum, paper, scrim, glass fiber tissue, or textile.

12. A radiation reflecting breather membrane according to claim 7, including substrate layers of non-woven polymer layers comprising polypropylene or polyester.
